(19) United States
(12) Patent Application Publication
(10) Pub. No.: US 2022/0263869 A1
(43) Pub. Date: Aug. 18, 2022

(54) DATA VALIDATION FOR ZERO COPY PROTOCOLS

(71) Applicant: Seagate Technology LLC, Fremont, CA (US)

(72) Inventors: Shankar Tukaram More, Pune (IN); Vidyadhar Pinglikar, Pune (IN); Shashank Ramesh Parulekar, Pune (IN)

(21) Appl. No.: 17/177,530

(22) Filed: Feb. 17, 2021

(51) Int. Cl. H04L 29/06; H04L 29/08

(52) U.S. Cl. CPC H04L 63/205; H04L 67/06; H04L 67/34; H04L 67/18

(57) ABSTRACT

Systems and methods are disclosed for data validation for zero copy protocols. In some examples, a server may include hardware, software, or a combination thereof to provide flexibility and data validation for a read request operation of a zero copy protocol. A read request operation can include a validation request frame, a status response frame, or both. In further examples, the validation request frame, the status response frame, or both can be configured by a requesting device to facilitate read data validation. In yet further examples, another device can receive a read request operation with a variably configured validation request frame, status response frame, or both and configure one or more data validation processes based on such.

### SUMMARY

In certain embodiments, an apparatus can include a first network interface configured to access a memory and to execute a zero copy protocol, and a circuit configured to send a read request to a zero copy device having a second network interface configured to execute the zero copy protocol. The read request including information indicating selected data the zero copy device is to send to the first network interface from the second network interface via the zero copy protocol. The read request also including a validation request frame including one or more configurable parameters that configure the zero copy device's validation process for the selected data.

In certain embodiments, a system can comprise a first zero copy device configured to send a read request to a second zero copy device to receive data at the first zero copy device from the second zero copy device via a zero copy protocol. The read request can include a field indicating a validation request is present within the read request. The first zero copy device can also be configured to receive a response to the read request, the response including validation information corresponding to the validation request.

In certain embodiments, a memory device can store instructions that when executed cause a processing device to perform a method including configuring, at a first device implementing a zero copy protocol, a read request operation of the zero copy protocol with a configurable validation parameter, sending the read request from the first device to a second device implementing the zero copy protocol, and receiving, at the first device from the second device, a response to the read request, the response including validation information corresponding to the validation request.

### BRIEF DESCRIPTION OF THE DRAWINGS

FIG. 1 is a diagram of a system of data validation for zero copy protocols, in accordance with certain embodiments of the present disclosure;

FIG. 2 is a diagram of a system of data validation for zero copy protocols, in accordance certain embodiments of the present disclosure;

FIG. 3 is a diagram of a system of data validation for zero copy protocols, in accordance with certain embodiments of the present disclosure;

FIG. 4 is a diagram of a system of data validation for zero copy protocols, in accordance with certain embodiments of the present disclosure;

FIG. 5 is a diagram of a system of data validation for zero copy protocols, in accordance with certain embodiments of the present disclosure;

FIG. 6 is a diagram of a system of data validation for zero copy protocols, in accordance with certain embodiments of the present disclosure; and

FIG. 7 depicts a flowchart of an example method for data validation for zero copy protocols, in accordance with certain embodiments of the present disclosure.

### DETAILED DESCRIPTION

In the following detailed description of certain embodiments, reference is made to the accompanying drawings which form a part hereof, and in which are shown by way of illustration of example embodiments. It is also to be understood that features of the embodiments and examples herein can be combined, exchanged, or removed, other embodiments may be utilized or created, and structural changes may be made without departing from the scope of the present disclosure.

In accordance with various embodiments, the methods and functions described herein may be implemented as one or more software programs running on a computer processor or controller. Dedicated hardware implementations including, but not limited to, application specific integrated circuits, programmable logic arrays, system-on-chip (SoC), and other hardware devices can likewise be constructed to implement the circuits, functions, processes, and methods described herein. Methods and functions discussed herein may be performed by modules, blocks, or engines, all of which may include one or more physical components of a computing device (e.g., logic, circuits, processors, controllers, etc.) configured to perform a particular task or job, or may include instructions that, when executed, can cause a processor to perform a particular task or job, or may be any combination thereof. Thus, a module, engine, or block may be any combination of computer hardware (including circuitry) and software that allows the corresponding functions and processes to be executed. Further, the methods described herein may be implemented as a computer readable storage medium or memory device including instructions that, when executed, cause a processor to perform the methods.

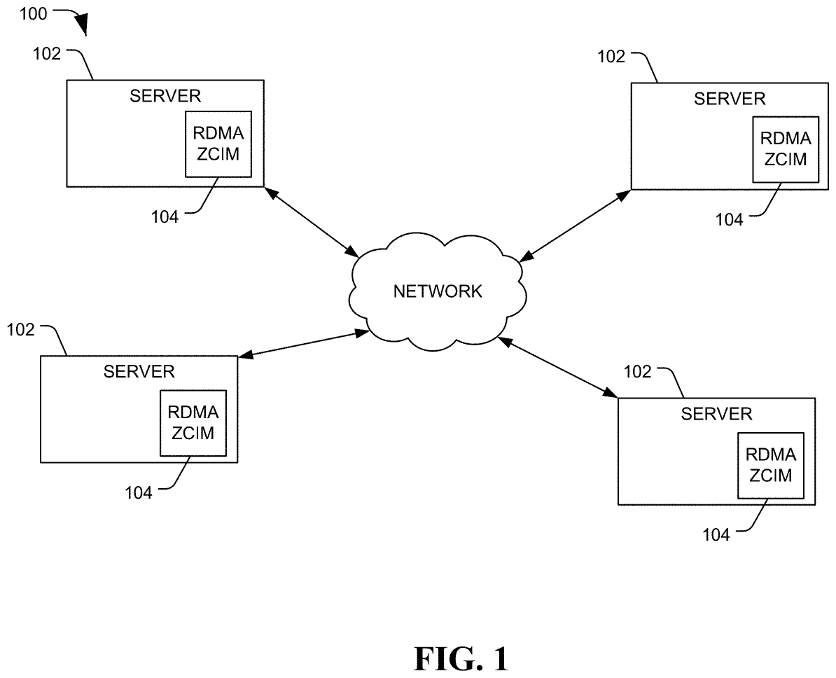

FIG. 1 shows a diagram of a system of data validation for zero copy protocols, generally designated 100, in accordance with certain embodiments of the present disclosure. The system 100 can include one or more computer servers 102 including a data integrity module such as a remote direct memory access (RDMA) based zero copy integrity module (ZCIM) 104. The zero copy validation module may include software and hardware, such as firmware, logic circuits, other circuits, memory, a controller or processor, an interface protocol, an interface connector, or any combination thereof that allows the functions and processes described herein to be performed.

Generally, a first ZCIM 104 may communicate with a second ZCIM 104 to transfer data between two servers 102 by enabling a network adapter to transfer data directly to or from application memory, eliminating the need to copy data between application memory and the data buffers of a corresponding operating system, which will require no work to be done by the central processing units (CPUs), caches, or context switches of the servers 102. Further, such data transfers can continue in parallel with other system operations and can reduce latency compared to other solutions.

In various embodiments, such as described herein, the ZCIM 104 can implement a validation mechanism and processes to determine data validation for a read request operation of a zero copy protocol. For example, a read request operation can include validation information (e.g., a validation request frame), status response information (e.g., a status response frame), or both. In further examples, the validation request frame, the status response frame, or both can be configured by a requesting device to facilitate read data validation. In yet further examples, another device can receive a read request operation with a variably configured validation request frame, status response frame, or both and configure one or more data validation or status response processes based on such. Detailed embodiments are discussed below.

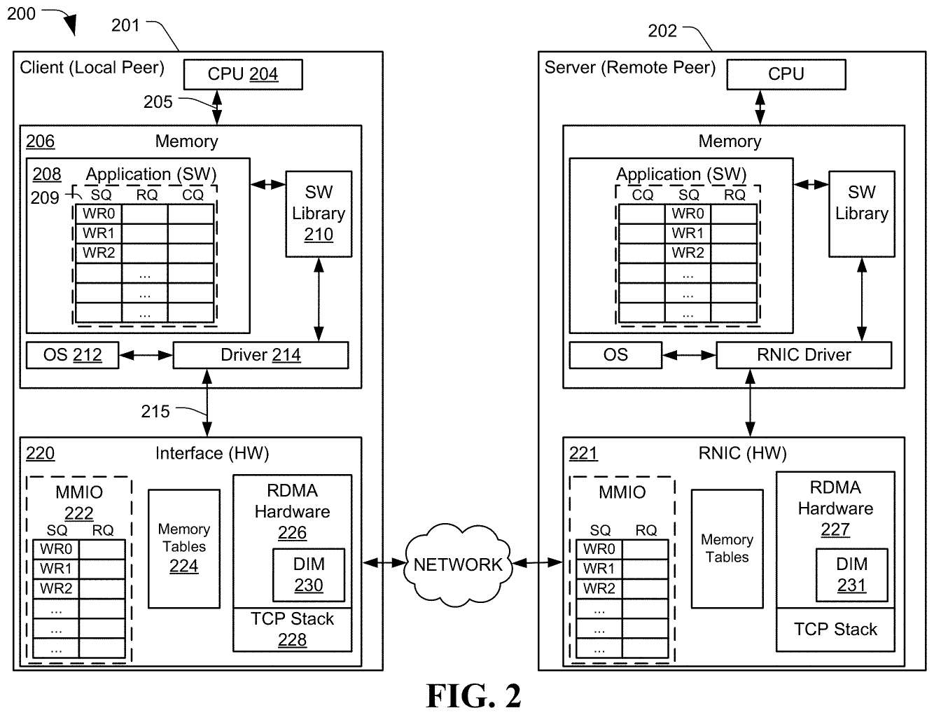

FIG. 2 shows a diagram of a system of data validation for zero copy protocols, generally designated 200, in accordance with certain embodiments of the present disclosure. The system 200 may be an example of system 100 and can include a first computer server 201 implementing a data integrity module (DIM) 230, which can be the ZCIM 104. The server 201 may further include a CPU 204, a processing bus 205, a system memory 206, a system bus 215, and a network interface 220. The hardware and software of system 100 and system 200 can perform the data integrity processes and functions described herein, including the validation processes and the status response processes.

In some embodiments, the system memory 206 can include an application buffer 208, a software (SW) library 210, an operating system 212, and an interface driver 214. The application buffer 208 may store multiple queues 209, such as a send queue (SQ), a receive queue (RQ), and a completion queue (CQ). The network interface 220 can be a hardware (HW) and SW based interface, such as a remote direct memory access (RDMA) enabled network interface controller (RNIC). The network interface 220 may include a memory mapped input/output (MMIO) 222 that is mapped to corresponding memory space in the application buffer 208, memory table(s) 224, RDMA hardware 226 (e.g., processor(s), physical memory, logic circuits, etc.), DIM 230, and a transmission control protocol (TCP) stack 228.

The network interface 220 can be operatively coupled to system memory 206 in a manner that enables direct memory access (DMA) data transfers between buffers on the network interface 220 and the system memory 206, such as via system bus 215, which may be a Peripheral Component Interconnect Express (PCIe) interconnect or similar interconnect.

Further, the SQ and RQ of the application buffer 208 can be mapped and directly accessed from the application address space 208 through use of the MMIO 222. For example, every time an application posts a new send (transmit) or receive work request (WR), this request can be added to the respective SQ or RQ of the application buffer 208 by the software library 210. The RNIC 220 can be operatively coupled to system memory 206 in a manner that enables DMA data transfers between buffers on RNIC 220 and system memory 206. Such can be facilitated by an interconnect 215, which may be a Peripheral Component Interconnect Express (PCIe) interconnect.

A portion of memory address space 209 can be allocated to the MMIO address space 222 for RDMA applications, which can be accessible by RNIC 220. The physical storage for data in the MMIO address space 222 may be located in system memory 206 or separately on RNIC 220. The SQ and RQ of MMIO 222 may be circular buffers comprising

a plurality of work request (WR) slots, which can be utilized for read requests.

The system 200 may also include a second computer server 202 implementing a compatible zero copy protocol, such as data integrity module 230. In some specific examples, such as shown in FIG. 2, server 202 may have a same configuration as server 201; however, such is not required as long as the servers can communicate via compatible zero copy protocols.

During operation, a zero copy operation may be initiated by server 201 via RDMA 226 to transfer data to server 202 by enabling a ZCIM, such as DIM 230, to transfer data directly to or from MMIO 222, eliminating the need to copy data between application memory 206 and data buffers of the corresponding operating system 212, which will require no work to be done by the CPU 204.

In various embodiments, such as described herein, the DIM 230 can implement a validation mechanism and processes to determine data validation for a read request operation of a zero copy protocol. A read request operation can include a validation request frame, a status response frame, or both. In further examples, the validation request frame, the status response frame, or both can be configured by a requesting device, such as RNIC 220, to facilitate read data validation. In yet further examples, another device, such as RNIC 221, can receive a read request operation with a variably configured validation request frame, status response frame, or both and configure one or more data validation processes based on such. Further details that can be implemented in the system 200 are discussed below.

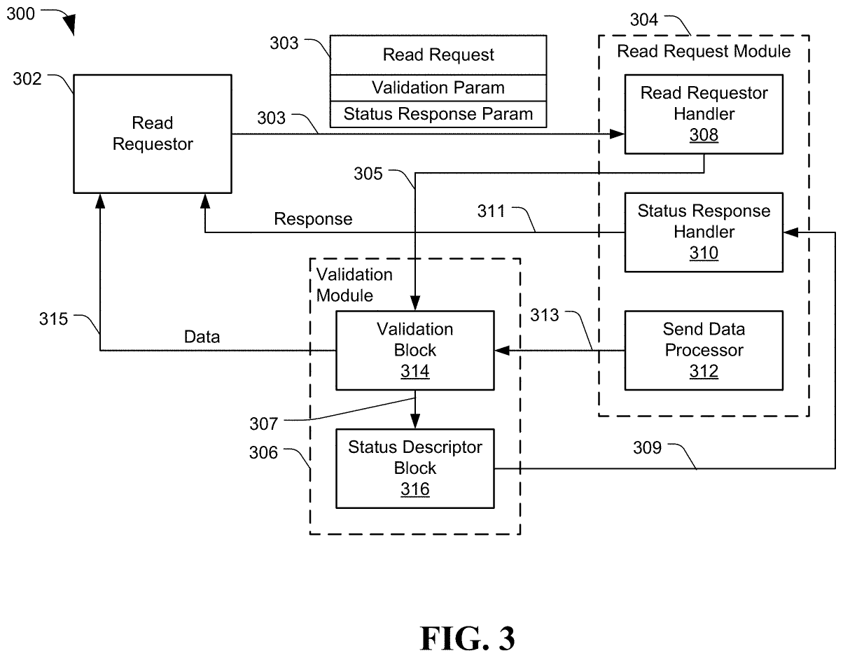

Referring to FIG. 3, a diagram of a system of data validation for zero copy protocols is shown and generally designated 300, in accordance with certain embodiments of the present disclosure. The system 300 can be utilized within system 100, 200, or with any of the other systems and methods described herein. System 300 can include a read requestor 302, which may be a first server implementing a first zero copy system, a read request module 304, and a validation module 306, where the read request module 304 and the validation 306 can be located at a second server implementing a second zero copy system compatible to communicate with the first zero copy system.

The read requestor 302 can configure a read request 303 to include various data integrity information, such as validation parameters or status response parameters, as discussed herein. The read requestor 302 can transmit, such as via an RDMA system, the read request 303 to the read request module 304.

The read request module 304 may include a read requestor handler 308, a status response handler 310, and a send data processor 312. The read requestor handler 308 can receive the read request 303 and process the read request 303, including parsing the read request 303 to extract the validation parameters and the status response parameters. The read requestor handler 308, or another functional block such as the validation block 314, may configure the validation process settings and the status response process settings of the second server based on the extracted parameters from the read request. The read request handler 308 can also send at least some of the validation parameters 305, such as a seed for validation (e.g., a logical block address or an object identifier), to the validation module 306 or the validation block 314.

The validation module 306, which may also be referred to as a data integrity module (DIM), may include a validation block 314 and a status descriptor block 316. The validation block 314 can receive validation parameters 305 from the read request handler 308 and perform validation functions based on the received validation parameters for data 313 received from the send data processor 312. Further, the send data processor 312 can retrieve the data 313 corresponding to the read request 303 and provide that data 313 to the validation block 314. The validation block 314 can send the requested data 315 to the read requestor 302 based on the data integrity settings of system 300. For example, in some cases, the data 315 may include errors that were detected by the validation block 314, such as in a video streaming application, where the system 300 has been designed to send the data regardless of the detected errors. However, in other examples, the system 300 may be designed to not send any of the data 313 to the read requestor 302 if there are any data integrity errors at the validation block 314, thus there may be no data 315 transmitted and the only transmission to the read requestor 302 may be the status response 311 indicating the error.

Generally, the validation block 314 can update the result of the validation to the status descriptor block 316. The validation block 314 may use a seed to compute a final validation field, which can then be utilized to determine if the retrieved data is valid such that the value stored in the final validation field will not match a computed validation value based on the retrieved data if there is a data error. The computed validation value can be calculated from its corresponding block size, type of validation computation requested, and the seed value. Further, the validation block 314 may inform the status descriptor block 316 if the data from the send data processor is valid or not. When there is an error, the validation block 314 can update the status block 316 with details such as an error block number or offset, an expected validation value, and a computed validation value. Further, the validation block 314 can also update a seed value for a next block's validation computation, which may include incrementing the seed value, decrementing the seed value, or not changing the seed value.

The validation block 314 can inform the status descriptor block 316 if data 313 is correct or not by sending error information 307. The status descriptor block 316 can accumulate a first set of error information 307 from the validation block 314 and provide a second set of error information 309 to the status response handler 310. The first set of error information 307 and the second set of error information 309 may be the same but do not have to be exactly the same; for example, the first set of error information 307 may include all error information the validation block 314 generates, whereas the second set of error information 309 may be filtered to only include the error information the read requestor 302 has required to be sent via the settings of the status response parameters, which may be a subset less than all of the error information. Further, the second set of error information 309 may have other status information, such as status response parameter settings, that are passed to the status response handler 310. In some embodiments, the status descriptor block 316, the status response handler 310, or both can be configured to filter error information based on the read requestor's 302 status response parameters.

The status response handler 310 can send a status 311 of the read request to the read requestor 302 including a status of the corresponding read request 303, error information 309, or both. The format of the status response 311 can be configurable based on the status response parameters in the read request 303. For example, the status response 311 can include information indicating whether the transferred data is valid or not, error location information (e.g., block identification, which could be one or more), error information, a validation value, or any combination thereof. If data validation is successful, with no errors, the status response 311 can be sent with an indicator that the data is valid. In some embodiments, the system 300 can be configured to not send a status response when there are no validation errors.

Generally, the status descriptor block 316 can provide a status 309 to the status response handler 310 per the read request 303 configuration. In some embodiments, the read request 303 can specify whether either a short descriptor of errors or a long descriptor of errors is to be included with the status response 311 sent to the read requestor 302. Further, the status descriptor block 316 can accumulate all errors from the validation block 314.

The client 302 can configure whether the server sends the data if there is a validation error. For example, in some applications, such as video, small errors might not be a problem and the data 315 can be sent even though validation was not successful; but in other applications, such as banking, an unsuccessful data validation might prevent the data 315 from ever being sent to the client 302.

The status response 311 can be in a format based on the parameters as set in the status response frame of the read request 303. In some embodiments, the status response handler 310 can send an expected validation value and a computed validation value, an indication of a successful validation or a failed validation, the details of the errors (e.g., a descriptor), or any combination thereof. For example, if a short error status descriptor is requested, the status response 311 may include a minimum block number that include an error and a maximum block number that included an error. If a long error status descriptor is requested, the status response 311 may include a list of all block numbers that include an error.

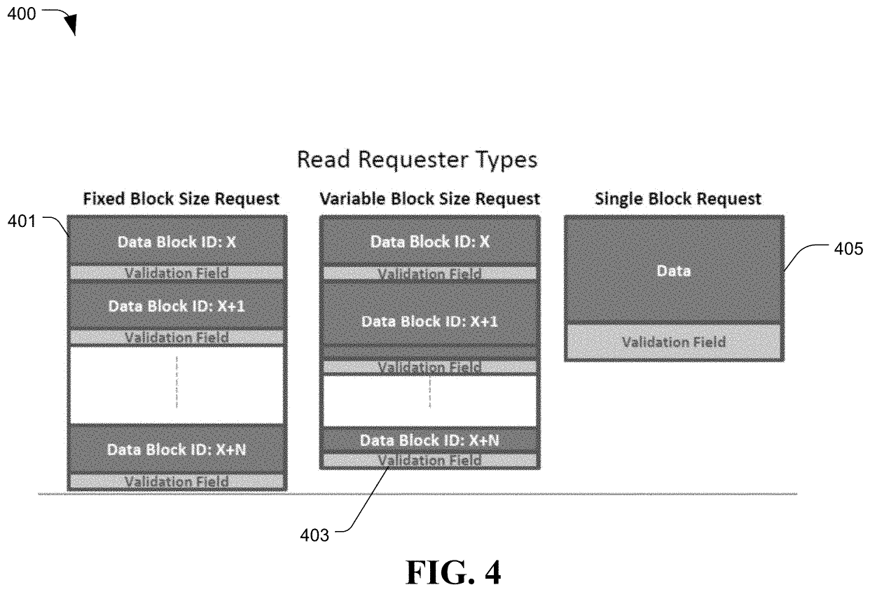

Referring to FIG. 4, a diagram of a system of data validation for zero copy protocols is shown and generally designated 400, in accordance with certain embodiments of the present disclosure. The system 400 can be utilized within system 100, 200, or with any of the other systems and methods described herein. System 400 shows various configurations of a read request of a zero copy protocol, such as a fixed block size request 401, a variable block size request 402, and a single block request 403.

Each of the configurations may have a validation field that includes validation parameters, response parameters, or both. The validation field can correspond with a specific data block or operation that is requested. Configurations for a fixed block size request 401 may be implemented when a system implementing a zero copy protocol, such as system 100 or 200, is configured such that each validation field is associated with a data block of a fixed size. Further, configurations for a variable block size request 402 may be implemented when a system implementing a zero copy protocol, such as system 100 or 200, is configured such that a data block, associated with a validation field, can have a variable size. Even further, configurations for a single block request 403 have a single block per request that is associated with a validation field.

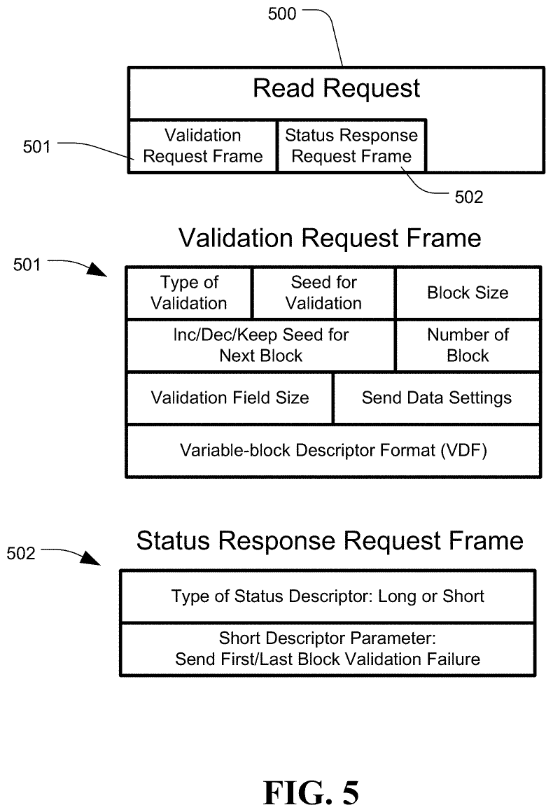

Referring to FIG. 5, a diagram of a system of data validation for zero copy protocols is shown, in accordance with certain embodiments of the present disclosure. A read request 500 may include a validation request frame 501 and a status response request frame 502. The read request 500 may be utilized by a system implementing an RDMA protocol or with any other protocol capable of performing a zero copy protocol, such as systems 100, 200, or with any of the other systems and methods described herein. The read request 500 may be transmitted to a system implementing a zero copy protocol to process the read request 500.

The validation request frame 501 may include multiple parameters, which may each be stored in one or more subframes, that allow a first zero copy integrity module to indicate settings for validating a corresponding read request, where the validation parameters can be transmitted to a second zero copy module for the validation settings to be implemented during execution of the corresponding read request. The parameters can include a type of validation, a seed for validation, a block size, an indicator of an action to take with respect to the seed, a number of a block, a validation field size, a send data parameter, a descriptor for a variable block size (e.g., variable-block descriptor format (VDF)), or any combination thereof.

In some embodiments, the validation parameters can include a type of validation parameter that can indicate to a receiving device a specific validation process for the receiving device to perform, such as checksum analysis process, a cyclic-redundancy-check (CRC) process, a seed validation process, or another validation process the receiving device is configured to implement. The seed for validation parameter can include a seed value that can be utilized in the validation process, such as a starting seed for a checksum validation process (e.g., a logical block address or an object identifier). A seed operation parameter can indicate an operation to perform with respect to the seed value. Example operations can include incrementing the seed value for a next operation, decrementing the seed value for a next operation, or keeping the same seed for the next operation. A block size parameter can indicate a specific size of a data block, which can be utilized in a validation process that needs to know a size of data. A number of blocks parameter can indicate a number of blocks the receiving device is expected to receive. The validation field size parameter can indicate a size of a validation field that is stored in the receiving server device during a write process, such as at the end of each data block corresponding to the read request. The send data parameter can include an indicator for the receiving server to determine what information is to be sent back to the requestor; for example, options to send data may include 1) removing the validation field and sending only the requested data to the requestor; 2) sending all the data corresponding to the read request even when there is an error; or 3) sending a subset of data, such as sending only a first data block and last data block corresponding to the read request when there is an error. The amount and type of data and error information sent to the requestor can have many variations depending on the requirements of the requestor.

A descriptor for a variable block size can be a variable-block descriptor format (VDF) parameter that, on a block-by-block basis, can indicate a block offset, a block size, a validation field size, or combinations thereof . In cases of variable block sizes being included in the read request, a requestor can use the VDF parameter to create a descriptor with a block size that indicates a current block size in bytes. In some variations, the VDF parameter may indicate a block offset by including a byte of data indicating an offset location; however, such is not required because there are multiple ways to determine an offset location, including computing an offset from summing a previous block's size. In further variations, the VDF parameter may indicate a validation field size; however, such is also optional as the validation field size parameter may be indicated as a global parameter in the validation request frame as discussed herein. Further, the validation settings and status send settings can also be global settings done once for multiple or all read requests.

The status response request frame 502 may include multiple parameters that allow a first zero copy module to indicate settings for a status response from a second zero copy module, where the status parameters can be transmitted to a second zero copy module for the status settings to be implemented in relation to the corresponding read request. The status response can be in a format based on the parameters as set in the status response frame and indicate whether the selected data transferred via the zero copy protocol is valid or contains any error. In some embodiments, the parameters can include a type of status description, a short descriptor parameter (which may also be referred to as an error descriptor parameter), or any variation thereof. Further, the validation request frame's parameters and the status request frame's parameters can be arranged in any format, such as a single frame including all of the parameters or a subset of the parameters, that can be parsed by the receiving device to determine the parameters.

In some embodiments, the status response parameters can include an indicator of a type of status response (e.g., short descriptor versus long descriptor), which may be selected from multiple available (e.g., pre-programmed) status response types, the requesting server expects from the server transferring the data and can also include a description parameter, which can indicate specific data corresponding to the data block is expected to be included in the status response. In some examples, one of a short descriptor type and a long descriptor type of status response may be identified via the type parameter. When a short descriptor type of status response is indicated, the description parameter may indicate that only a subset less than all of the error information available concerning a requested data block is to be included in the status response; for example, the status response parameters may require the server sending the short descriptor status response could include an indication of a first error block location within the data and an indication of a last error block within the data even though there may be other blocks having error within the data. When a long type of status response is indicated, the description parameter may not be needed by the server sending the status response, as the long type of status response may require all error information to be sent; however, the description parameter can also be utilized for indicating that all information is to be included in the status response.

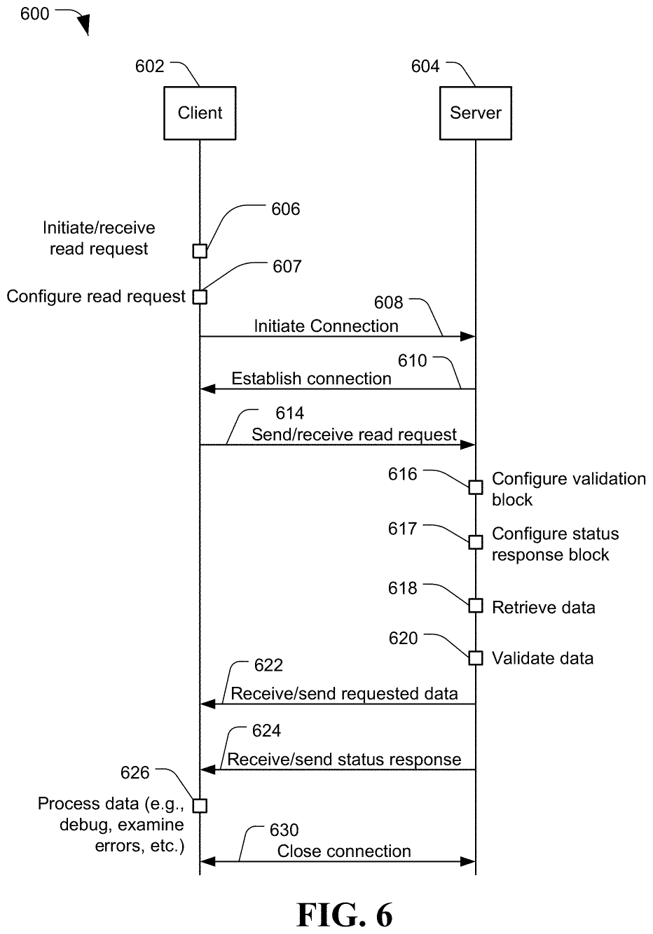

Referring to FIG. 6, a diagram of a system of data validation for zero copy protocols is shown and generally designated 600, in accordance with certain embodiments of the present disclosure. The system 600 may be utilized by systems 100, 200, or with any of the other systems and methods described herein, or with any system that can implement a zero copy protocol. The system 600 can include a first computing device 602, which may be a computer server implementing a zero copy protocol, and a second computing device 604, which also may be a computer server implementing a zero copy protocol. The server 602, which may be referred to as a client device, can initiate a zero copy protocol data transfer from the server 604.

FIG. 6 also shows an example timing process of communications between server 602 and server 604 to utilize a zero copy protocol to perform a data transfer and validation thereof. The processes and communications can be implemented via a combination of hardware and software within a server, such as via an RNIC of the client 602 and another RNIC of the server 604. Utilizing a zero copy protocol, the client server 602 can initiate a read request process, at 606. The client server 602 may configure a read request, at 607, which can include configuring validation parameters and status response parameters as part of the read request. A zero copy module of client 602 can then initiate a connection with a zero copy module of the server 604, at 608, via the zero copy protocol; the server 604 can then respond to establish a communications connection with the client 602, at 610.

Once the communications connection is established, the client 602 may send the read request to the server 604, at 614. When the server 604 receives the read request, the server 604 can configure a validation process based on the validation parameters included in the read request, at 616. The server 604 may also configure a status response process based on the status response parameters included in the read request, at 617. In some situations, the server 604 may not need to reconfigure already existing processes if there are no differences from a preset configuration to what the read request parameters request.

Once the validation and status response processes are configured, the server 604 can retrieve the data associated with the read request, at 618, and perform the validation process on the retrieved data, at 620. The server 604 can then, based on the validation settings, send the requested data to the client 602, at 622. The server 604 can also send a status response based on the status response settings to the client 602, at 624. The status response, at 624, could be sent to the client 602 before the data is sent, at 622, or with the data transmission, or any variation thereof.

When the client 602 receives the requested data and the status response, the client 602 can validate the data, at 626. Once the transmission to the client 602 is complete, either the server 604 or the client 602 may close the connection between the two, at 630.

FIG. 6 shows example embodiments of how a zero copy protocol can communicate between a client and a server. One skilled in the art will recognize that many of the separate communications shown could be combined, done in a different order, or performed in another manner without departing from the scope of this disclosure. More details and examples with respect to the processes shown or referred to in this communications timing diagram of FIG. 6 are provided with respect to the flowchart of FIG. 6.

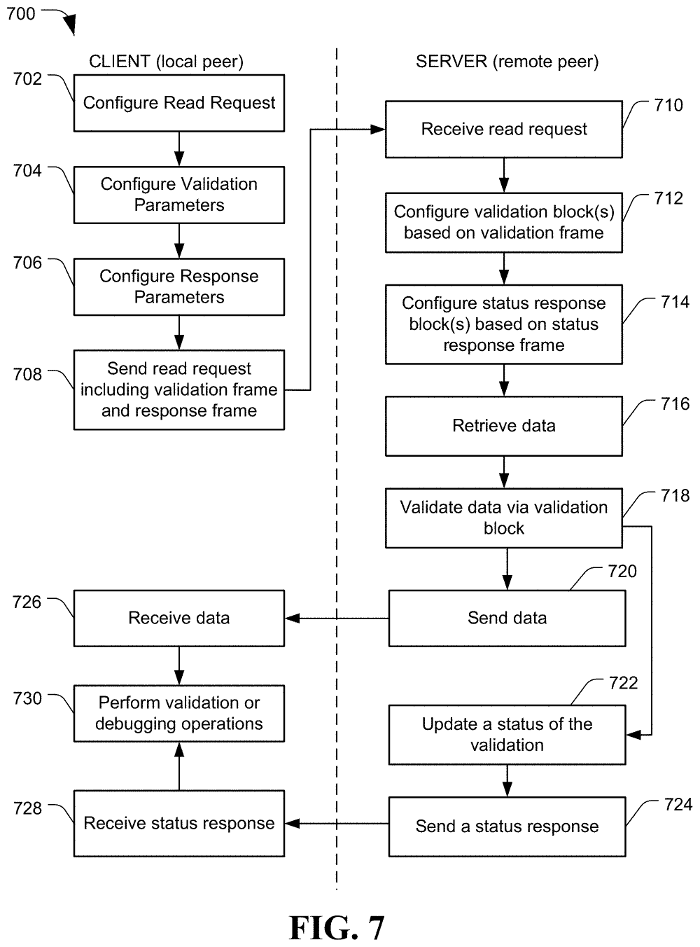

Referring to FIG. 7, a flowchart of an example method for data validation for zero copy protocols is shown and generally designated 700, in accordance with certain embodiments of the present disclosure. The methods and processes shown in and discussed in relation to FIG. 7 may be utilized by a system systems 100, 200, or with any of the other systems and methods described herein, or with any system that implements a zero copy protocol. Generally, method 700 provides a solution to allow a system implementing a zero copy protocol to implement a data validation process for requested data. As discussed herein, a requesting ZCIM device can set various instruction parameters corresponding to the validation process, such as validation requirements, status response requirements, or both; examples of such parameters are discussed with respect to FIG. 5.

The zero copy read request process 700 can be initiated at a client computing device, sometimes referred to as a local peer, which may be a computer server implementing a zero copy protocol and module as discussed herein. Generally, a read request can be initiated, such as by RDMA hardware 226 posting a work request for read data to the SQ of MMIO 222, when the client requires data that is not stored locally and is known to be at another device connected via a network, such as a server, which sometimes may be referred to as a remote peer. The process 700 can include configuring the read request, at 702, which can include the client device generating and configuring a read request, such as discussed with respect to FIG. 5. The client can also configure validation parameters, at 704, response parameters, at 706, or both. In some embodiments, configuring the read request, at 702, configuring the validation parameters, at 704, and configuring the status response parameters, at 706, may be within a single process or sub-processes of a larger process. The client may send the read request to the server, at 708. In some embodiments, these process steps can be performed via an RDMA system, a zero copy system, or a combination thereof, such as RDMA hardware 226 and DIM 230. For example, a client device can configure a read request based on how data was created and saved at the server, such as by indicating a block size, a validation field size, or both in the read request. A read request frame may be sent via any network communication protocol, such as TCP/IP (Internet Protocol).

The server may receive the read request, at 710, and process the read request. The server may configure a validation process, at 712, based on the validation parameter(s) (e.g., those within a validation frame of the read request) of the read request. The server may also configure status response process, at 714, based on the status response parameter(s) (e.g., those within a status response frame of the read request) of the read request. The process 700 may then retrieve the data corresponding to the read request, at 716. In some embodiments, these process steps can be performed via RDMA logic, a zero copy module, or a combination thereof, such as RDMA hardware 227 and DIM 231.

The process 700 can validate data using the validation process that was previously configured, at 718. The validation process can produce indicator data that indicates whether the data to be transferred is valid or not; the indicator data is data in addition to the data that was requested be transferred via the read request and may be referred to as metadata. In some instances, the indicator data may not indicate a determination of whether the data is valid but can indicate an error(s) or likelihood of data being valid. The process 700 may then determine, or create, a status response of the read request based on the indicator data and the previously setup status response process, at 722.

The server can send the requested data to the client, at 720, and the status response to the client, at 724. These transmissions to the client may be sent in multiple transmissions or may be combined into a single transmission. The metadata provided in the status response, at 724, can allow the client to perform validation operations on the requested data, debugging of the read request, or both.

The client can receive the requested read data, at 726, and the status response, at 728. As previously discussed, the transmissions may be received as a single transmission or as multiple transmissions. The client can then perform validation operations on the requested data, debugging of the read request, or both, at 730.

As one skilled in the art will note, a system could implement either solutions of sending validation information or sending status response information, or could implement both solutions. Thus, the solutions described herein allow a server implementing a zero copy protocol to enhance a read request by including validation information, status response requirements, or both. The data integrity systems and processes disclosed herein can include a configurable validation process, a configurable status response process, or both. These data integrity solutions allow a zero copy protocol to be more efficient, as the zero copy protocol/RDMA does not need to access memory buffers (e.g., memory 206) corresponding to a server's main CPU to validate data. Thus, this can provide for a validation system with reduced latency compared to other solutions.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the above embodiments can be made, and other embodiments not specifically described herein will be apparent to those of skill in the art upon reviewing the description. Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. An apparatus comprising:
a first network interface configured to access a memory and to execute a zero copy protocol;
a circuit configured to:
send a read request to a zero copy device having a second network interface configured to execute the zero copy protocol, the read request including:
information indicating selected data the zero copy device is to send to the first network interface from the second network interface via the zero copy protocol; and
a validation request frame including one or more configurable parameters that configure the zero copy device's validation process for the selected data.

2. The apparatus of claim 1 further comprising the validation request frame including a validation type subframe indicating a selected type of validation the zero copy device's validation process will perform based on the validation type subframe.

3. The apparatus of claim 1 further comprising the validation request frame including a validation field size subframe indicating a size of a validation field previously stored by a write operation for one or more data blocks corresponding to the read request.

4. The apparatus of claim 1 further comprising the validation request frame including a seed parameter subframe indicating a logical block address or an object identifier.

5. The apparatus of claim 1 further comprising the validation request frame including a block size parameter subframe indicating a specific block size.

6. The apparatus of claim 1 further comprising the validation request frame including a send data subframe indicating requested data the zero copy device is to send back in response to the read request, where the requested data is selected from a first option to send only the selected data and no validation information and a second option to send the selected data and validation information.

7. The apparatus of claim 1 further comprising:
the read request including a status response frame including one or more configurable parameters that configure the zero copy device's status response process for the read request; and
the circuit configured to receive a status response from the zero copy device via the first network interface, the status response being in a format based on the status response frame and indicating whether the selected data transferred via the zero copy protocol is valid.

8. The apparatus of claim 7 further comprising the status response frame including a status type subframe that indicates a selection of one of multiple available status response types to be sent from the zero copy device to the first network interface.

9. The apparatus of claim 7 further comprising the status response includes an error descriptor subframe that indicates that only a subset less than all of available error information concerning a requested data block is to be included in the status response.

10. A system comprising:
a first zero copy device configured to:
send a read request to a second zero copy device to receive data at the first zero copy device from the second zero copy device via a zero copy protocol, the read request including a field indicating a validation request is present within the read request; and
receive a response to the read request, the response including validation information corresponding to the validation request.

11. The system of claim 10 further comprising the validation request including a first parameter that configures the second zero copy device's validation process corresponding to the read request.

12. The system of claim 11 further comprising the first parameter includes a validation type indicator indicating a selected type of validation the second zero copy device's validation process will perform based on the validation type indicator.

13. The system of claim 11 further comprising the read request includes a status response indicator including a second parameter that configures the second zero copy device's status response corresponding to the read request.

14. The system of claim 13 further comprising the status response indicator including a status response type that indicates a selection of one of multiple available status response types to be sent from the second zero copy device to the first zero copy device.

15. The system of claim 13 further comprising the response from the second zero copy device configured in a format required by the second parameter and includes, when an error is indicated in the validation information, an identification of one or more blocks which had an error.

16. A memory device storing instructions that when executed cause a processing device to perform a method comprising:
configuring, at a first device implementing a zero copy protocol, a read request operation of the zero copy protocol with a configurable validation parameter;
sending the read request from the first device to a second device implementing the zero copy protocol; and
receiving, at the first device from the second device, a status response to the read request, the status response including validation information corresponding to the validation request.

17. The memory device of claim 16 further comprising the method including selecting the validation parameter to determine a type of data validation process the second device performs corresponding to the read request.

18. The memory device of claim 17 further comprising the method including:
configuring the read request operation with a configurable status response parameter; and
selecting the configurable status response parameter to determine a type of status response the second device provides to the first device in response to the read request.

19. The memory device of claim 16 further comprising the method including receiving, at the first device from the second device, data corresponding to the read request and a validation value as part of the status response.

20. The memory device of claim 19 further comprising the method including comparing validation value to an expected value to determine an error within the received data.
